(19) United States
(12) Patent Application Publication
(10) Pub. No.: US 2003/0138050 A1
(43) Pub. Date: Jul. 24, 2003

(54) Dynamic image receiver and dynamic image transmitter

(76) Inventors: Yoshihisa Yamada, Tokyo (JP); Shinichi Kuroda, Tokyo (JP); Kazuo Sugimoto, Tokyo (JP); Fuminobu Ogawa, Tokyo (JP); Kohtaro Asai, Tokyo (JP)

Correspondence Address: BIRCH STEWART KOLASCH & BIRCH, PO BOX 747, FALLS CHURCH, VA, 22040-0747, US

(21) Appl. No.: 10/296,493

(22) PCT Filed: Mar. 20, 2002
(86) PCT No.: PCT/JP02/02718

(30) Foreign Application Priority Data
Mar. 30, 2001 (JP) 2001100370

(51) Int. Cl. H04N 7/173; H04B 1/66; H04N 7/12; H04N 11/02; H04N 11/04

(52) U.S. Cl. 375/240.25; 725/90; 348/563; 348/387.1

(57) ABSTRACT

A plurality of moving picture transmitters (11 to 1n) encode a plurality of input objects, respectively, and transmit them onto a network (41). A moving picture receiver (21) receives bitstream data transmitted from each of the plurality of moving picture transmitters (11 to 1n), obtains information on the quality of the network (41), detects an error or the like that occurs in the bitstream data, and transmits priority information on the plurality of objects to the plurality of moving picture transmitters (11 to 1n), respectively. A registration server 31 registers information on the plurality of moving picture transmitters (11 to 1n) and information on the moving picture receiver 21 therein, and delivers them according to circumstances.

### FIELD OF THE INVENTION

The present invention relates to a moving picture receiver that receives two or more bitstream data encoded on an object-by-object basis and decodes the two or more bitstream data so as to produce a moving picture and a moving picture transmitter that transmits bitstream data encoded on an object-by-object basis. Particularly, it relates to a moving picture receiver and a moving picture transmitter capable of dynamically changing the priorities assigned to individual objects, the priorities being considered when encoding the objects.

### BACKGROUND OF THE INVENTION

Part-2 Visual of MPEG-4 (Moving Picture Experts Group Phase-4) which is an internationally standardized encoding system is provided as a technique for dividing a moving picture signal into a plurality of objects and then encoding them, for example. In MPEG-4 Visual, picture objects of rectangular shape or arbitrary shape are defined, and a method of decoding one or more picture object signals and a method of decoding shape information are standardized. However, no encoding system is standardized, and therefore if bitstream data which complies with those decoding methods can be output, any processing can be carried out during encoding. In other words, a plurality of encoding means for encoding objects need not consist of one encoder according to the MPEG-4 standard. A plurality of encoders arranged on a network can encode individual objects and output encoded results, respectively. For example, Japanese patent application publication No. 2000-92489 discloses a picture encoding apparatus provided with a plurality of encoding units each of which controls encoding of an individual object. This picture encoding apparatus assigns priorities to individual objects, respectively, each of the priorities indicating the quality of bitstream data on a corresponding object, and carries out processings, such as inputting, encoding, multiplexing, and rate controlling of a moving picture signal, in real time.

A problem with a prior art moving picture receiver and prior art moving picture transmitters constructed as mentioned above is that it is impossible to dynamically change the priorities respectively assigned to individual objects with time, each of the priorities indicating the quality of bitstream data on a corresponding object.

Another problem is that it is impossible to perform rate controlling by dynamically changing the priorities respectively assigned to individual objects, each of the priorities indicating the quality of bitstream data on a corresponding object, by using encoded bitstream data pre-stored in a storage server instead of encoding the plurality of objects in real time.

The present invention is proposed to solve the above-mentioned problems, and it is therefore an object of the present invention to provide a moving picture receiver and a moving picture transmitter capable of interactively specifying priority information indicating the quality of bitstream data provided on an object-by-object basis on a side of the moving picture receiver, and performing a control processing according to the quality of a network (the frequency of occurrence of bit errors and packet loss, a transmission delay, a jitter and so on.

It is another object of the present invention to provide a moving picture receiver and a moving picture transmitter capable of, when outputting encoded bitstream data from a storage server for storing the bitstream data, controlling the bitstream being output according to the specified priorities of objects.

### DISCLOSURE OF THE INVENTION

A moving picture receiver in accordance with the present invention includes a bitstream receiving means for receiving a plurality of bitstream data from a moving picture transmitter, a decoding means for decoding the plurality of received bitstream data, and a data transmitting means for transmitting priority information defined on an object-by-object basis to the moving picture transmitter.

As a result, the moving picture receiver that decodes the bitstream data can interactively specify the priority of each object.

A moving picture receiver in accordance with the present invention includes a bitstream receiving means for receiving a plurality of bitstream data, a decoding means for decoding the plurality of received bitstream data, and a data transmitting means for transmitting priority information defined on an object-by-object basis to a moving picture transmitter, the receiver allowing a registration server to select objects which can be received by the receiver based on both priority information on a priority assigned to an object, which is transmitted from the moving picture transmitter registered in the registration server, and information on a decoding ability of the decoding means, and the receiver receiving bitstream data on the selected objects from the moving picture transmitter.

As a result, when making the storage server output encoded bitstream data, the moving picture receiver can allow the storage server to select bitstream data to be output from the moving picture transmitter according to the priorities of objects specified by the moving picture receiver.

A moving picture transmitter in accordance with the present invention includes an encoding means for encoding a picture so as to produce bitstream data on an object-by-object basis, a bitstream transmitting means for transmitting the bitstream data produced by the encoding means to a moving picture receiver, a data receiving means for receiving priority information on the priorities respectively assigned to objects transmitted from the moving picture receiver, and an encoding control means for controlling the encoding means based on the priority information received by the data receiving means.

As a result, the moving picture transmitter can transmit the bitstream data on objects according to the priorities of the objects interactively specified by the moving picture receiver.

A moving picture transmitter in accordance with the present invention includes a plurality of bitstream storing means for storing a plurality of bitstream data obtained by encoding a picture on an object-by-object basis, respectively, a data receiving means for receiving priority information on the priorities respectively assigned to objects transmitted from a moving picture receiver, a selecting means for selecting one bitstream storing means from among the plurality of bitstream storing means based on the priority information received by the data receiving means, and a bitstream transmitting means for transmitting bitstream data stored in the selected bitstream storing means.

As a result, the moving picture transmitter can transmit the bitstream data on objects according to the priorities of the objects interactively specified by the moving picture receiver.

### BRIEF DESCRIPTION OF THE FIGURES

FIG. 1 is a block diagram showing an example of a system provided with a moving picture receiver and a plurality of moving picture transmitters in accordance with embodiment 1 of the present invention;

FIG. 2 is a block diagram showing the structure of each of the plurality of moving picture transmitters in accordance with embodiment 1;

FIG. 3 is a block diagram showing the structure of the moving picture receiver in accordance with embodiment 1;

FIG. 4 is a block diagram showing the structure of a registration server in accordance with embodiment 1;

FIG. 5 is a block diagram showing the structure of each of a plurality of moving picture transmitters in accordance with embodiment 4 of the present invention; and

FIG. 6 is a block diagram showing another example of a system provided with a moving picture receiver and a plurality of moving picture transmitters in accordance with any one of embodiments 1 to 4 of the present invention.

### PREFERRED EMBODIMENTS OF THE INVENTION

In order to explain the present invention in greater detail, the preferred embodiments will be described below with reference to the accompanying figures. Embodiment 1.

In accordance with embodiment 1 of the present invention, a moving picture receiver is so constructed as to receive a plurality of objects transmitted from a plurality of moving picture transmitters.

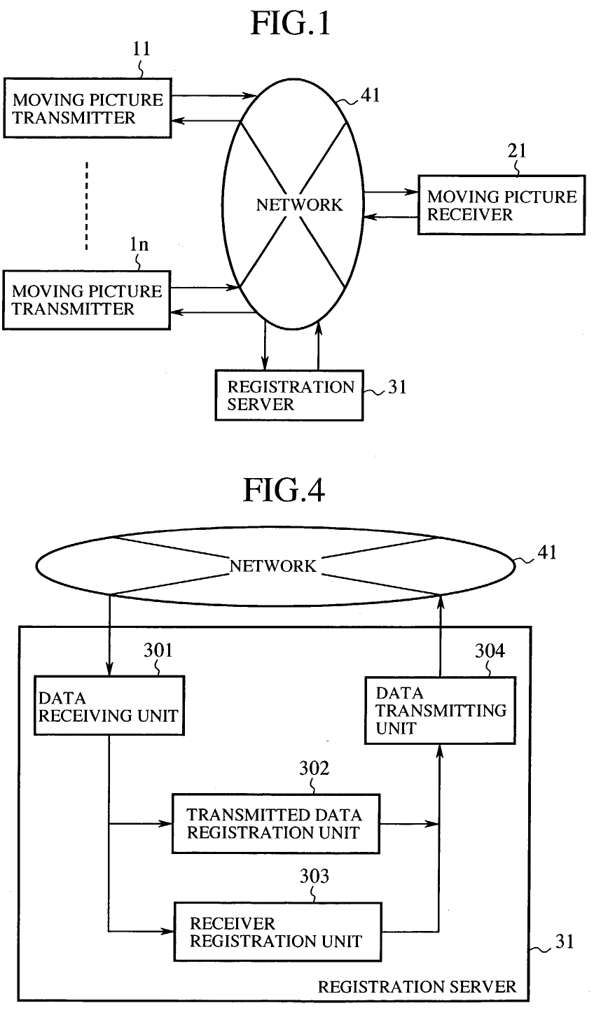

FIG. 1 is a block diagram showing an example of a system provided with a moving picture receiver and a plurality of moving picture transmitters according to embodiment 1 of the present invention. In the figure, reference numerals 11 to 1n denote the n moving picture transmitters, respectively, reference numeral 21 denotes the moving picture receiver, reference numeral 31 denotes a registration server for registering data on the n moving picture transmitters 11 to 1n which exist on a network, contents data described later, and so on therein, and reference numeral 41 denotes the network, such as a public line network or a packet network, to which these apparatuses are connected.

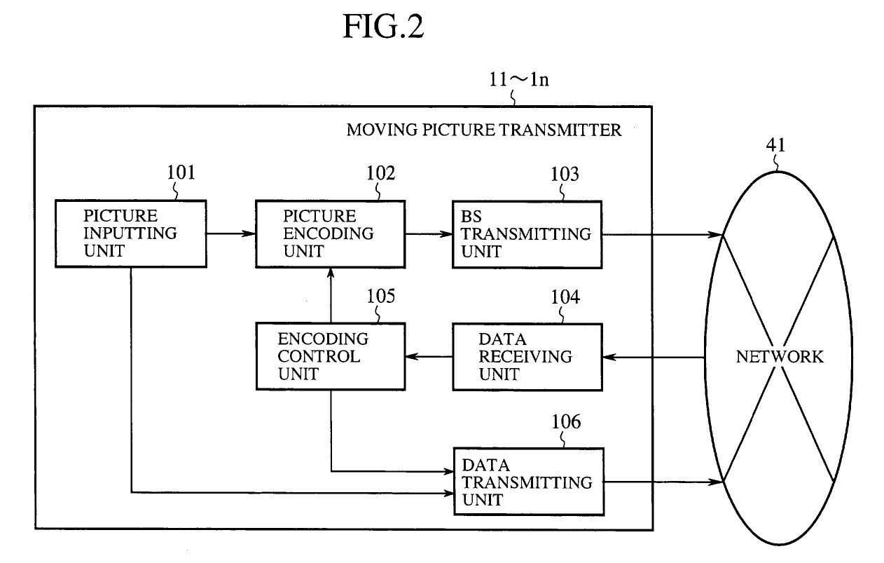

FIG. 2 is a block diagram showing the structure of each of the n moving picture transmitters 11 to 1n according to embodiment 1. In the figure, reference numeral 101 denotes a picture inputting unit, reference numeral 102 denotes a picture encoding unit, reference numeral 103 denotes a bitstream transmitting unit (referred to as BS transmitting unit from here on) for transmitting encoded bitstream data, reference numeral 104 denotes a data receiving unit for receiving various data such as a compression rate of bitstream data, which is defined on an object-by-object basis, priority information indicating the quality of each bitstream data, such as a bit rate, and quality information on the quality of the network, reference numeral 105 denotes an encoding control unit for controlling the picture encoding unit 102, and reference numeral 106 denotes a data transmitting unit for sending out contents data described later onto the network.

As previously mentioned, in accordance with embodiment 1, the plurality of moving picture transmitters 11 to 1n are provided. However, the present invention is not limited to this configuration, and there can be alternatively provided a moving picture transmitter including a plurality of sets each provided with a picture inputting unit 101, a picture encoding unit 102, a BS transmitting unit 103, a data receiving unit 104, an encoding control unit 105, and a data transmitting unit 106, for producing and sending out encoded bitstream data on a plurality of objects to the moving picture receiver. In this case, because the moving picture transmitter can perform a timesharing processing, the number of objects to be encoded is not necessarily equal to the number of sets disposed in the moving picture transmitter, for processing those objects, each set including the plurality of processing units 101 to 106.

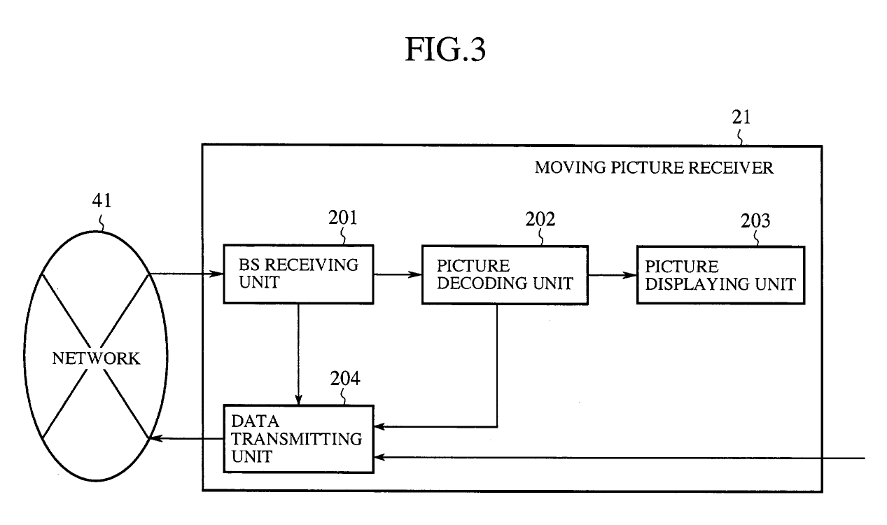

FIG. 3 is a block diagram showing the structure of the moving picture receiver 21 according to embodiment 1. In the figure, reference numeral 201 denotes a bitstream receiving unit (referred to as BS receiving unit from here on) for receiving bitstream data by way of the network 41, reference numeral 202 denotes a picture decoding unit for decoding the received bitstream data, reference numeral 203 denotes a picture displaying unit for displaying a produced picture signal, and reference numeral 204 denotes a data transmitting unit for transmitting priority information used for encoding and quality information on the quality of the network to the plurality of moving picture transmitters 11 to 1n by way of the network 41.

FIG. 4 is a block diagram showing the structure of the registration server 31 according to embodiment 1. In the figure, reference numeral 301 denotes a data receiving unit for receiving data on the plurality of moving picture transmitters 11 to 1n and the contents data transmitted from the plurality of moving picture transmitters 11 to 1n, and reception ability data transmitted from the receiver 21 by way of the network 41, reference numeral 302 denotes a transmitted data registration unit for storing the data on the plurality of moving picture transmitters 11 to 1n, the contents data described later, and the priority information used for encoding each object therein, reference numeral 303 denotes a receiver registration unit for storing the reception ability data on a decoding ability of the picture decoding unit 202 included in the moving picture receiver 21 therein, reference numeral 304 denotes a data transmitting unit for transmitting the data on the plurality of moving picture transmitters 11 to 1n, the contents data, and the priority information to the receiver 21, and for transmitting the priority information and the quality information on the quality of the network 41, by way of the network 41, to the plurality of moving picture transmitters 11 to 1n.

Next, a description will be made as to the operation of the system.

First of all, the operation of each of the plurality of moving picture transmitters 11 to 1n as shown in FIG. 2 will be explained. A picture signal input to the picture inputting unit 101 is sent to the picture encoding unit 102. The picture encoding unit 102 performs an encoding processing on the picture signal by using, for example, an encoding system like an MPEG-4 system so as to produce bitstream data. The bitstream data output from the picture encoding unit 102 is converted into data having a format suitable for the network 41 by the BS transmitting unit 103, and is then sent out onto the network 41. When the network 41 is a packet network, for example, the BS transmitting unit 103 packetizes the bitstream data into a plurality of packets each having a predetermined size, and adds predetermined header information (a serial number, time information, and so on) to each of the plurality of packets. When the network 41 has a high possibility that errors occur, the BS transmitting unit 103 adds an error detection flag to the bitstream data if necessary.

The data receiving unit 104 receives the priority information and the quality information on the quality of the network 41 sent from the registration server 31 and the moving picture receiver 21. The encoding control unit 105 sets parameters associated with encoding, such as a bit rates and a frame rate, based on the priority information and the quality information on the quality of the network 41, which are received by the data receiving unit 104, so as to control the picture encoding unit 102.

The data transmitting unit 106 transmits information on a plurality of objects input from the picture inputting unit 101 or from outside the moving picture transmitter (for example, information indicating the nature of each object, such as whether each object is a person or a background, the on-screen position of each object, a relation between the plurality of objects with respect to a vertical direction, and information indicating the state of the picture signal, such as the size of the picture signal), and the parameters associated with encoding, such as a bit rate and a frame rate set by the encoding control unit 105, to the moving picture receiver 21 by way of the network 41. A combination of the information on the plurality of objects and the parameters associated with encoding is referred to as contents data.

Next, the operation of the moving picture receiver 21 as shown in FIG. 3 will be explained. The BS receiving unit 201 receives a plurality of bitstream data transmitted from the plurality of moving picture transmitters 11 to 1n in the above-mentioned way. At that time, in the case of packet communications the BS receiving unit 201 determines whether or not each packet has been lost by checking the serial number included in the header information of each packet, and determines the time (transmission delay) that elapses until each packet arrives at the BS receiving unit by using time information included in the header information and the amount of fluctuation of the transmission delay in each packet. Furthermore, when an error detection flag is added to each packet, the BS receiving unit 201 detects an error (bit error) that can occur in data carried by each packet.

The picture decoding unit 202 decodes the received bitstream data so as to produce a picture, and the picture displaying unit 203 displays the produced picture. At that time, the picture decoding unit 202 can simultaneously check to see whether or not data that cannot be decoded is included in the received bitstream data. In order to receive a plurality of objects at the same time, the picture decoding unit 202 can be provided with a plurality of BS receiving units 201 and a plurality of picture decoding units 202 for performing a parallel processing, or can time-share one BS receiving unit 201 and one picture decoding unit 202. The picture displaying unit 203 then performs a composition processing on the plurality of objects thus received so as to display them thereon.

The data transmitting unit 204 transmits the quality information on the quality of the network 41 detected by the BS receiving unit 201, the information on decoding errors that occur in the bitstream data and that are detected by the picture decoding unit 202, and the priority information on the priority assigned to each object given by a user of this moving picture receiver 21 or an external apparatus connected to the moving picture receiver 21 to the plurality of moving picture transmitters 11 to 1n by way of the network 41.

The data transmitting unit 204 further transmits the information on the reception ability of the moving picture receiver 21, which is determined by the abilities of the BS receiving unit 201 and picture decoding unit 202 included in the moving picture receiver 21, such as a maximum number of objects which can be decoded with the moving picture receiver 21, a maximum size of objects which can be decoded with the moving picture receiver 21, a maximum bit rate, and a maximum frame rate, to the registration server 31 by way of the network 41.

Next, the operation of the registration server 31 as shown in FIG. 4 will be explained. The registration server 31 registers information on the plurality of moving picture transmitters 11 to 1n arranged on the network 41 and information on the moving picture receiver 21 therein, and delivers those pieces of information registered therein to the plurality of moving picture transmitters 11 to 1n and the moving picture receiver 21 if necessary.

The data receiving unit 301 receives information on objects sent from each of the plurality of moving picture transmitters 11 to 1n, contents data, such as parameters associated with encoding, and information on the reception ability of the moving picture receiver 21 sent from the moving picture receiver 21 by way of the network 41. Before transmitting the contents data, each of the plurality of moving picture transmitters 11 to 1n identifies the registration server 31 in advance. As an alternative, the registration server 31 looks for the plurality of moving picture transmitters 11 to 1n that exist on the network 41 so as to make a request for transmission of the contents data.

The transmission data registration unit 302 registers received contents data and data on one of the plurality of moving picture transmitters 11 to 1n which has transmitted the received contents data, for example, data for identifying the moving picture transmitter which has transmitted the received contents data, a telephone number, the moving picture transmitter's name, the moving picture transmitter's IP address, and the priority information on the priority assigned to an encoded object associated with the contents data therein. The receiver registration unit 303 registers the information on the reception ability of the moving picture receiver 21, which has been received by the data receiving unit 301, therein.

The data transmitting unit 304 transmits the contents data registered in the transmission data registration unit 302, the data on the plurality of moving picture transmitters 11 to 1n, and the priority information to the moving picture receiver 21. Two ways of transmitting these data will be explained hereafter.

The first method is a method of selecting one or more pieces of contents data from among the contents data registered by the registration server 31, and transmits the combination of the selected pieces of contents data to the moving picture receiver 21. In other words, the data transmitting unit 304 selects one or more transmitters from among the plurality of moving picture transmitters 11 to 1n, i.e., one or more objects so that the amount of data to be transmitted does not go beyond the reception ability of the moving picture receiver 21 registered in the receiver registration unit 303, i.e., the number of selected objects does not exceed the maximum number of objects that can be received by the moving picture receiver 21, so that the total size of the selected objects does not exceed the maximum size of objects which can be received by the moving picture receiver 21, so that the number of bits included in the selected objects does not exceed the maximum number of bits which can be received by the moving picture receiver 21, or so that a rate at which frames included in the selected objects are to be transmitted does not exceed the maximum frame rate at which the selected objects can be received by the moving picture receiver 21. Of course, the data transmitting unit 304 can read information on each object from the contents data registered in the transmission data registration unit 302, and can perform a selection processing, such as nonselection of two or more backgrounds, nonselection of similar objects at the same time, or nonselection of two or more objects which are to be placed on-screen at the same position.

In accordance with the second method, the moving picture receiver 21 selects one or more pieces of contents data from the contents data registered by the registration server 31, and causes the registration server 31 to transmit the combination of the selected pieces of contents data thereto. Concretely, when a user uses the moving picture receiver 21 so as to access the registration server 31, for example, the registration server 31 provides the registered contents data for the moving picture receiver 21. Then the user can select one or more desired contents data from the registered contents data by using the moving picture receiver 21. Then, when the combination of the selected desired contents data goes beyond the reception ability, the moving picture receiver 21 warns the user to make a reselection of contents data. When this second method is used, the receiver registration unit 303 of the registration server 31 becomes unnecessary.

The moving picture receiver 21 receives the data on objects from the plurality of moving picture transmitters 11 to 1n, the contents data on the parameters associated with encoding, and the data on the plurality of moving picture transmitters 11 to 1n from the registration server 31. The moving picture receiver 21 receives bitstream data from the plurality of moving picture transmitters 11 to 1n by way of the network 41 based on those received data.

In other words, because the registration server 31 analyzes the data registered in the transmission data registration unit 302 and also analyzes the information on the decoding ability registered in the receiver registration unit 303 so as to select one or more objects which can be received by the moving picture receiver 21, and transmits information for identifying corresponding ones of the plurality of moving picture transmitters 11 to 1n, which encodes the selected objects, and information on the encoded objects to the moving picture receiver 21, the moving picture receiver 21 receives the information for identifying the selected ones of the plurality of moving picture transmitters 11 to 1n, so that the moving picture receiver 21 can receive bitstream data from each of the selected ones of the plurality of moving picture transmitters 11 to 1n.

As previously explained, in accordance with embodiment 1, the moving picture receiver 21 and the registration server 31 are independently disposed. However, the present invention is not limited to this configuration, and the registration server 31 can be disposed in the moving picture receiver 21. As an alternative, the moving picture receiver 21 can be integral with the registration server 31. These variants can be made in any one of other embodiments explained below.

Furthermore, in accordance with embodiment 1, the moving picture receiver 21 transmits the reception ability data on the decoding ability or the like of the moving picture receiver 21 to the registration server 31 while transmitting plural pieces of priority information on the priorities assigned to a plurality of objects to the plurality of moving picture transmitters 11 to 1n, respectively, as previously mentioned. However, the present invention is not limited to this exemplary case, and the moving picture receiver 21 can transmit the plural pieces of priority information on the priorities respectively assigned to a plurality of objects and the reception ability data on the decoding ability or the like of the moving picture receiver 21 to the plurality of moving picture transmitters 11 to 1n, respectively. In this case, the registration server 31 becomes unnecessary. These variants can be made in any one of other embodiments explained below.

As mentioned above, in accordance with this embodiment 1, because the moving picture receiver 21 can interactively specify the priority information indicating the quality of bitstream data on an object which should be transmitted by each of the plurality of moving picture transmitters 11 to 1n, the moving picture receiver 21 can control the plurality of moving picture transmitters 11 to 1n so as to select bitstream data provided on an object-by-object basis which the moving picture receiver 21 can receive.

Embodiment 2.

In accordance with embodiment 2 of the present invention, a moving picture receiver, which are receiving bitstream data on a plurality of objects transmitted from a plurality of moving picture transmitters, can dynamically change a priority assigned to each of the plurality of objects according to a user's operation.

The moving picture receiver and the plurality of moving picture transmitters according to embodiment 2 of the present invention have the same structures as those as explained in Embodiment 1, and therefore the explanation of those components will be omitted hereafter.

Next, a description will be made as to the operation of the moving picture receiver and the operation of each of the plurality of moving picture transmitters.

The moving picture receiver 21 according to embodiment 2, which is so constructed as shown in FIG. 3, notifies the plurality of moving picture transmitters 11 to 1n of the priorities respectively assigned to a plurality of objects, which are input from outside the moving picture receiver 21, by using a data transmitting unit 204.

For example, when a user, who operates the moving picture receiver 21, observes a produced picture displayed on a picture displaying unit 203, and assigns priorities to a plurality of on-screen objects according to the preferences of the user, the priority information on the priorities is transmitted onto a network 41 through the data transmitting unit 204.

Usually, each of the plurality of moving picture transmitters 11 to 1n assigns a higher priority, as an initial value, to such a subject object as a person, and assigns a lower priority, as an initial value, to such an object as a background having a little movement, and then performs encoding controlling according to such priorities. When the user makes a request to see a background object more in detail by operating the moving picture receiver 21, for example, the plurality of moving picture transmitters 11 to 1n raise the priority assigned to the background object so that the data compression rate of the background object is decreased.

The data transmitting unit 204 of the moving picture receiver 21 thus changes the priority information according to such a user's operation and then transmits the changed priority information to a registration server 31 and one of the plurality of moving picture transmitters 11 to 1n which encodes the corresponding object.

When receiving the changed priority information by way of the data receiving unit 104, the corresponding one of the plurality of moving picture transmitters 11 to 1n outputs this priority information to an encoding control unit 105. The encoding control unit 105 changes the encoding parameters according to the change request from the user and controls encoding according to the changed encoding parameters.

When the user changes the priority information on the priority assigned to an object, the moving picture receiver 21 can also change the priority information on any other object according to the changed priority information at the same time. As a result, a further advantage explained below is provided. For example, because when the priority assigned to an object is lowered, the amount of generated codes of the object decreases, the amount of codes of other objects can be increased by only the amount of codes of the object whose priority is lowered. Then, when the priority assigned to an object is lowered, the priorities respectively assigned to other objects can be raised at the same time. In contrast, when the priority assigned to an object is raised, there is a necessity to lower the priority assigned to other objects. The registration server 31 can perform such adjustment of the priority information, in place of the moving picture receiver 21. In this case, the same advantage is provided.

As mentioned above, in accordance with this embodiment 2, because the moving picture receiver 21 which is receiving a plurality of objects can change the priority information according to a user's operation and transmit the changed priority information to the registration server 31 and the plurality of moving picture transmitters 11 to 1n, the moving picture receiver 21 can dynamically change the priority assigned to each of the plurality of objects according to the preferences of the user.

Furthermore, because when changing the priority assigned to an object, the moving picture receiver 21 can also change the priorities respectively assigned to other objects, the present embodiment offers an advantage of being able to maintain the amount of generated codes included in the bitstream data on the plurality of objects constant.

Embodiment 3.

A moving picture receiver and a plurality of moving picture transmitters in accordance with embodiment 3 of the present invention can dynamically change the priorities respectively assigned to a plurality of objects according to the quality of a network, such as the frequency of occurrence of transmission errors or packet loss, or a transmission delay.

The moving picture receiver and the plurality of moving picture transmitters according to embodiment 3 of the present invention have the same structures as those as explained in Embodiment 1, and therefore the explanation of those components will be omitted hereafter.

Next, a description will be made as to the operation of the moving picture receiver and the operation of each of the plurality of moving picture transmitters.

A measurement of the quality of a network 41 is carried out by adding error detection codes to the bitstream data at fixed intervals of a predetermined number of bits, or by adding a serial number to each packet in the case of packet communications, for example. Furthermore, a detection of the transmission delay is carried out by adding time information to the bitstream data at fixed intervals of a predetermined number of bits, or by adding time information to each packet or packets being sent out at fixed intervals in the case of packet communications.

The moving picture receiver 21 according to embodiment 3 measures the quality of the network 41 by using information transmitted from each of the plurality of moving picture transmitter 11 to 1n according to the above-mentioned method. A BS receiving unit 201 performs this measurement and changes the settings of the priorities respectively assigned to the plurality of objects according to a measurement result. A data transmitting unit 204 transmits the changed priority information to the plurality of moving picture transmitters 11 to 1n, which encodes the plurality of objects, respectively, and a registration server 31.

An example of changing of the settings of the priorities respectively assigned to the plurality of objects, i.e., changing of the priority information will be explained below. When the quality of the network 41 is not so high, for example, when a transmission error or packet loss occurs, or when a large transmission delay is generated or a large fluctuation occurs in the transmission delay, the registration server 31 or the moving picture receiver 21 provides an instruction to lower the priorities for the plurality of moving picture transmitters 11 to 1n each of which transmits bitstream data by way of the low-quality network 41. Then, each of the plurality of moving picture transmitters 11 to 1n reduces the bit rate at which it transmits the bitstream data on a corresponding object to be transmitted according to the instruction to lower the priorities. As a result, the amount of bits that travel on the network 41 decreases, and therefore the congestion in the network 41 can be reduced. A method of strengthening the immunity to bit errors of the bitstream data to be transmitted is also effective as a measure against the occurrence of transmission errors.

In contrast, when the quality of the network 41 is very high, for example, when no transmission error or no packet loss occurs, or when a small fluctuation occurs in the transmission delay, there is no necessity for changing the priorities. When the quality of the network 41 is high, it is not necessary to transmit any instruction to change the priorities to the plurality of moving picture transmitters 11 to 1n which encode the plurality of objects, respectively. However, it is also effective to transmit an instruction to raise the priorities to the plurality of moving picture transmitters 11 to 1n when the reception ability of the moving picture receiver 21 goes beyond the current bit rate. Thus, each of the plurality of moving picture transmitters 11 to 1n, which has received the instruction to raise the priorities, raises the bit rate, so that the quality of a moving picture signal produced by the moving picture receiver 21 is improved.

In accordance with embodiment 3, the moving picture receiver 21 measures the quality of the network 41, and then transmits the priority information changed based on a measurement result to the plurality of moving picture transmitters 11 to 1n. As an alternative, the moving picture receiver 21 can transmit information on the quality of the network 41 directly to the plurality of moving picture transmitters 11 to 1n so that the encoding control unit 105 of each of the plurality of moving picture transmitters 11 to 1n changes encoding parameters according to the quality of the network 41. Even in this case, the same advantage is provided.

In accordance with embodiment 3, the BS receiving unit 201 of the moving picture receiver 21 detects and transmits the quality of the network 41. However, the present invention is not limited to this configuration, and a picture decoding unit 202 can transmit information on decoding errors that have been detected in the bitstream data to the plurality of moving picture transmitters 11 to 1n.

As mentioned above, in accordance with this embodiment 3, because the moving picture receiver 21 dynamically changes the priorities respectively assigned to a plurality of objects according to the quality of the network 41, such as the frequency of occurrence of transmission errors or packet loss, or the transmission delay, and provides an instruction to change the priorities to the plurality of moving picture transmitters 11 to 1n which encode the plurality of objects, respectively. Thus, the present embodiment offers an advantage of being able to appropriately control the plurality of moving picture transmitters 11 to 1n according to the quality of the network 41.

Embodiment 4.

Each of a plurality of moving picture transmitters according to embodiment 4 of the present invention, instead of accepting a picture signal and encoding it in real time, stores bitstream data encoded in advance therein, and then transmits the bitstream data according to the priority of a corresponding object, which is dynamically changed.

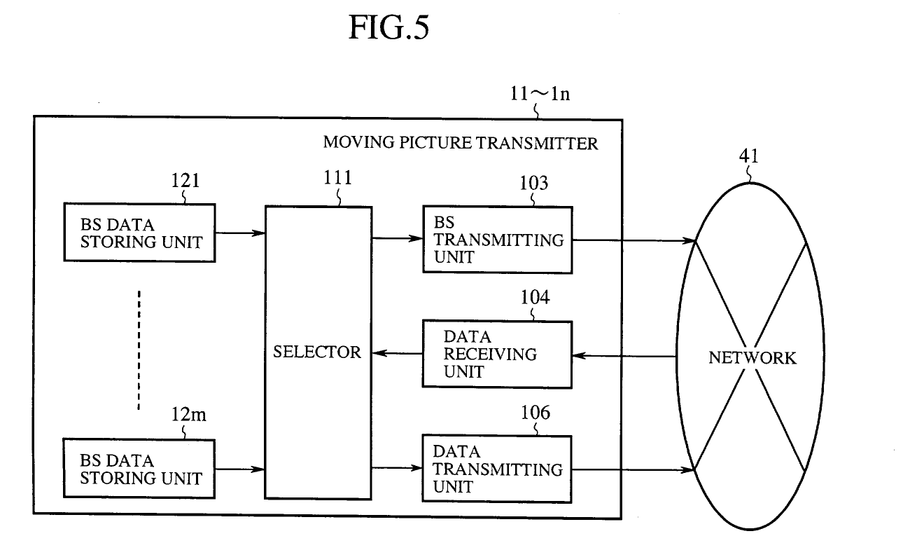

FIG. 5 is a block diagram showing the structure of each of the plurality of moving picture transmitters 11 to 1n according to embodiment 4 of the present invention. The same components as those of each of the plurality of moving picture transmitters 11 to 1n of above-mentioned embodiment 1 or like components are designated by the same reference numerals as shown in FIG. 2 and therefore the explanation of those components will be omitted hereafter. In the figure, reference numerals 121 to 12m denote bitstream data storing units (referred to as BS data storing units from here on) each for pre-storing bitstream data having a different bit rate for an identical object, and reference numeral 111 denotes a selector for selecting one bitstream data which should be transmitted from among a plurality of bitstream data stored in the plurality of BS data storing units 121 to 12m. Each of the plurality of moving picture transmitters 11 to 1n according to embodiment 4 of the present invention has a BS transmitting unit 103, a data receiving unit 104, and a data transmitting unit 106, which are the same as those as shown in FIG. 2. In other words, each of the plurality of moving picture transmitters 11 to 1n according to embodiment 4 stores pre-encoded bitstream data. Each of the plurality of moving picture transmitters 11 to 1n stores a plurality of bitstream data encoded with a plurality of bit rates in the plurality of BS data storing units 121 to 12m, as shown in FIG. 5, for an object which is the target of changing of the priority.

Next, a description will be made as to the operation of a moving picture receiver and the operation of each of the plurality of moving picture transmitters.

Each of the plurality of moving picture transmitters 11 to 1n receives priority information on an object, which is being transmitted thereby, from the moving picture receiver 21 or a registration server 31 by using a data receiving unit 104. When the priority information sent from the moving picture receiver 21 indicates that the current priority assigned to the object is lowered, the selector 111 selects one BS data storing unit that stores bitstream data having a smaller bit rate from among the plurality of BS data storing units 121 to 12m, and outputs the selected bitstream data to the BS transmitting unit 103 and allows the BS transmitting unit 103 to transmit the selected bitstream data onto the network 41. In contrast, when the priority information sent from the moving picture receiver 21 indicates that the current priority assigned to the object is raised, the selector 111 selects one BS data storing unit that stores bitstream data having a larger bit rate from among the plurality of BS data storing units 121 to 12m, and outputs the selected bitstream data to the BS transmitting unit 103 and allows the BS transmitting unit 103 to transmit the selected bitstream data onto the network 41.

When using interframe predictive coding adopted by the MPEG-4 standard or the like as an encoding system for encoding bitstream data, there is a possibility that when switching between bitstream data and then performing a decoding processing on switched bitstream data so as to produce picture frames from the middle, those frames are not correctly produced. When producing a picture from the middle, it is preferable that intraframe predictive coding is performed on the entire screen of the picture to be produced from the middle. The screen on which intraframe predictive coding has been performed is defined as I-VOP according to the MPEG-4 standard.

Therefore, when encoding bitstream data with interframe predictive coding adopted by the MPEG-4 standard, and switching between two bitstream data provided for the same object, as shown in the FIG. 5, according to the priority assigned to the object, I-VOPs are inserted into each bitstream data so that they are placed at fixed intervals. As a result, the moving picture receiver 21 can correctly process the moving picture by decoding and displaying the encoded bitstream data from an I-VOP.

Furthermore, when switching between two of the plurality of bitstream data by using the selector 111, the encoding of corresponding frames in the form of I-VOPs makes it possible to display the moving picture smoothly regardless of the switching. To this end, in accordance with this embodiment 4, when encoding an identical object with different bit rates, each of the plurality of moving picture transmitters encodes it so that each corresponding frame is encoded as an I-VOP. It is also effective to insert a GOV (Group Of Video Object Plain) header, which is allowed to be inserted according to the MPEG-4 standard, or header information accompanied by a unique word, such as a VOL (Video Object Layer) header, a VO (Visual Object) header, or a VOS (Visual Object Sequence) header, just before an I-VOP is inserted at fixed intervals. As a result, the moving picture receiver 21 can easily detect head positions of the bitstream data by detecting such headers, and can correctly perform an image processing.

Furthermore, even if each of the plurality of moving picture transmitters 11 to 1n receives an instruction to change the priority assigned to the corresponding object and then switches between bitstream data at once, the moving picture receiver 21 starts decoding data starting from an I-VOP for the above-mentioned reason. Therefore the moving picture receiver 21 cannot correctly display the moving picture in most instances even if it can decode the previous bitstream data. To avoid this problem, after receiving an instruction to change the priority, each of the plurality of moving picture transmitters 11 to 1n keeps transmitting the previous bitstream data which has been being transmitted up to now, then switches between the plurality of BS data storing units 121 to 12m at a timing when an I-VOP appears for the first time, and selects and outputs other bitstream data having a different bit rate, without switching from the previous bitstream data to the other bitstream data at once. As a result, unnecessary bitstream data which cannot be correctly decoded is prevented from being transmitted to the moving picture receiver 21. Thus, the moving picture receiver 21 can display the produced moving picture which does not fall into disorder and never becomes interrupted.

To this end, each of the plurality of moving picture transmitters 11 to 1n has to know the position of the next I-VOP inserted into the bitstream data being currently transmitted thereby and the position of an I-VOP inserted into other bitstream data to which the current bitstream data is to be switched, in advance. As soon as the selector 111 receives an instruction to change the priority, the selector 111 pre-reads the bitstream data being currently transmitted, then detects the position of the next I-VOP inserted into the bitstream data being currently transmitted, so that each of the plurality of moving picture transmitters 11 to 1n will transmit up to the next I-VOP, and simultaneously detects the position of an I-VOP of other bitstream data, to which the current bitstream data is to be switched, and will transmit the other bitstream data after transmitting up to the next I-VOP of the current bitstream data.

As an alternative, because the plurality of bitstream data having different bit rates are produced and are stored in advance, each of the plurality of moving picture transmitters 11 to 1n can detect the positions of I-VOPs inserted into each of the plurality of bitstream data in advance when producing or storing them so as to produce a table in which those I-VOP positions are listed. In this case, because the selector 111 need not perform the pre-reading processing and the detecting processing at the same time while the current bitstream data is being transmitted, the load on each of the plurality of moving picture transmitters 11 to 1n can be reduced.

When producing the plurality of bitstream data, each of the plurality of moving picture transmitters 11 to 1n can additionally insert VOS headers, VO headers, VOL headers, or GOV headers, according to the insertion of I-VOPs. However, when an instruction to change the priority is not provided to the selector 111 and the data transmitting unit 103, that is, when no instruction to switch between the plurality of bitstream data is provided, instead of sending the current bitstream data into which VOS headers, VO headers, VOL headers, or GOV headers are additionally inserted according to the insertion of I-VOPs, each of the plurality of moving picture transmitters 11 to 1n can remove the VOS headers, the VO headers, the VOL headers, or the GOV headers which have been inserted into the current bitstream data. In this case, each of the plurality of moving picture transmitters 11 to 1n need not transmit unnecessary header information, so that the network 41 can be used with a high degree of efficiency and the moving picture receiver 21 can recognize that the bit rate has been changed when the received bitstream data have header information added thereto, whereas the moving picture receiver 21 can recognize that the bit rate has not been changed when the received bitstream data have no header information.

Usually, the number of bits included in intraframe-predictive-encoded data is about 2 to 4 times that included in interframe-predictive-encoded data. Therefore, when intraframe-predictive-coding a plurality of objects at the same time, the amount of bits (the number of packets in the case of packet communications) transmitted onto the network 41 increases temporarily and therefore there is a danger that the network 41 will tighten. If the network 41 tightens, the transmission delay increases while there is a high possibility that packets are lost, so that reduction in service occurs in the moving picture receiver 21.

To avoid such a situation, the plurality of moving picture transmitters 11 to 1n control themselves so that the plurality of objects to be transmitted onto the network 41 are not intraframe-predictive-encoded at the same time. This controlling can be implemented by inserting intraframe-predictive-encoded data at intervals of either a sum of “a fixed value and a small random number” rather than a fixed value, or a value simply different by object, or by inserting intraframe-predictive-encoded data at fixed intervals but at different times for the plurality of objects, so that intraframe-predictive-encoded data are not produced at the same time among the plurality of objects.

As an alternative, the registration server 31, the moving picture receiver 21, or the like can provide a different value indicating the length of intervals at which intraframe-predictive-encoded data are inserted for each of the plurality of moving picture transmitters 11 to 1n on an object-by-object basis, so as to prevent the intraframe-predictive-encoded data from being produced at the same time, or can provide a different value indicating the timing at which intraframe-predictive-encoded data are inserted for each of the plurality of moving picture transmitters 11 to 1n on an object-by-object basis while fixing the length of intervals at which the intraframe-predictive-encoded data are inserted, so as to prevent the intraframe-predictive-encoded data from being produced at the same time.

In either of above-mentioned embodiments 1 to 4, the picture decoding unit 202 and the picture displaying unit 203 are disposed in the moving picture receiver 21. However, the present invention is not limited to this configuration, and the moving picture receiver 21 can have a means for storing received bitstream data instead of the picture decoding unit 202 and the picture displaying unit 203, and a means for storing a produced picture signal instead of the picture displaying unit 203.

Furthermore, in accordance with either of above-mentioned embodiments 1 to 4, as shown in FIG. 1, there is illustrated a system in which the plurality of moving picture transmitters 11 to 1n, the moving picture receiver 21, and the registration server 31 are arranged on the same network 41. However, the present invention is not limited to this system configuration.

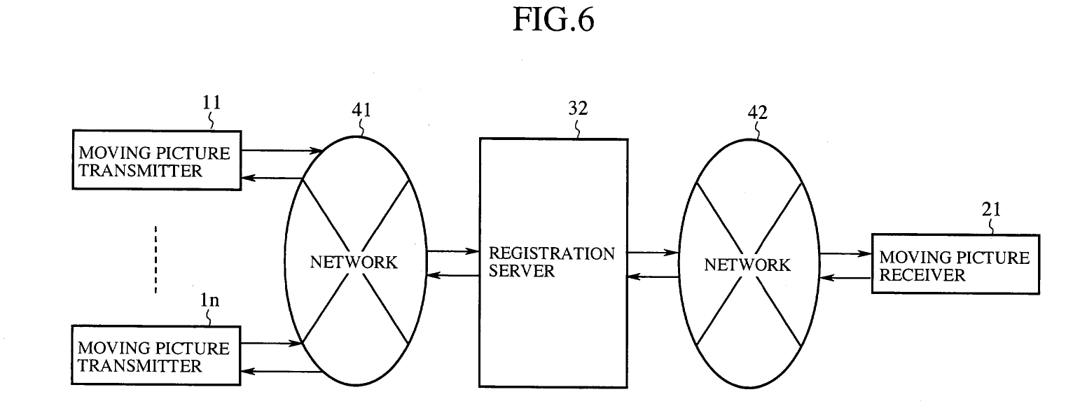

FIG. 6 is a block diagram showing another example of the system provided with the moving picture receiver and the plurality of moving picture transmitters according to any one of embodiments 1 to 4 of the present invention. The same components as those of the system of FIG. 1 or like components are designated by the same reference numerals as shown in FIG. 1 and therefore the explanation of those components will be omitted hereafter. In FIG. 6, reference numeral 32 denotes a registration server, and reference numeral 42 denotes a network.

In the system provided with the moving picture receiver 21 and the plurality of moving picture transmitters 11 to 1n, as previously explained in embodiments 1 to 4, the plurality of moving picture transmitters 11 to 1n and the moving picture receiver 21 can be arranged on the networks 41 and 42, respectively, as shown in FIG. 6. The registration server 32 can serve as a gateway between the two networks 41 and 42. When the system is configured as shown in FIG. 6, the registration server 32 can be so constructed as to measure the quality of the network 41 on which the plurality of moving picture transmitters 11 1n are arranged, send information on a measurement result to the plurality of moving picture transmitters 11 to 1n, and measure the quality of the network 42 on which the moving picture receiver 21 is placed or receive a measurement result from the moving picture receiver 21 and send information on the measurement result to the moving picture transmitter 21.

Industrial Applicability

As mentioned above, the moving picture receiver and the plurality of moving picture transmitters in accordance with the present invention are suitable for performing appropriate moving picture communications because the moving picture receiver dynamically specifies the quality of bitstream data provided on an object-by-object basis and each of the plurality of moving picture transmitters transmits bitstream data having a high quality, which offers good receiving conditions.

1. A moving picture receiver that receives a plurality of bitstream data encoded on an object-by-object basis from a moving picture transmitter so as to produce a picture, characterized in that said receiver comprises:
a bitstream receiving means for receiving the plurality of bitstream data;
a decoding means for decoding said plurality of received bitstream data; and
a data transmitting means for transmitting priority information defined on an object-by-object basis to said moving picture transmitter.

2. The moving picture receiver according to claim 1, characterized in that said decoding means includes a picture displaying means for displaying a picture of decoded objects, and when priority information is specified for each object displayed by said picture displaying means, said data transmitting means transmits the specified priority information to said moving picture transmitter.

3. The moving picture receiver according to claim 1, characterized in that said bitstream receiving means detects quality of a network that each object uses when receiving bitstream data on each object, and said data transmitting means transmits the quality of the network to said moving picture transmitter as the priority information on each object.

4. The moving picture receiver according to claim 1, characterized in that said decoding means detects a decoding error when decoding bitstream data on each object, and said data transmitting means transmits the detected decoding error to said moving picture transmitter as the priority information on each object in which the decoding error has been detected.

5. The moving picture receiver according to claim 1, characterized in that said receiver selects objects which can be received based on priority information on a priority assigned to an object, which is transmitted from said moving picture transmitter, and information on a decoding ability of said decoding means, and receives bitstream data on the selected objects.

6. A moving picture receiver connected to a registration server and a moving picture transmitter by way of a network, for receiving a plurality of bitstream data encoded on an object-by-object basis from said moving picture transmitter so as to produce a picture, characterized in that said receiver comprises:
a bitstream receiving means for receiving the plurality of bitstream data;
a decoding means for decoding said plurality of received bitstream data; and
a data transmitting means for transmitting priority information defined on an object-by-object basis to said moving picture transmitter, and characterized in that said receiver allows said registration server to select objects which can be received based on both priority information on a priority assigned to an object, which is transmitted from said moving picture transmitter registered in said registration server, and information on a decoding ability of said decoding means, and receives bitstream data on the selected objects.

7. A moving picture transmitter that transmits bitstream data encoded on an object-by-object basis to a moving picture receiver, characterized in that said transmitter comprises:
an encoding means for encoding a picture so as to produce bitstream data on an object-by-object basis;
a bitstream transmitting means for transmitting the bitstream data produced by said encoding means to said moving picture receiver;
a data receiving means for receiving priority information on priorities respectively assigned to objects transmitted from said moving picture receiver; and
an encoding control means for controlling said encoding means based on the priority information received by said data receiving means.

8. A moving picture transmitter that transmits bitstream data encoded on an object-by-object basis to a moving picture receiver, characterized in that said transmitter comprises:
a plurality of bitstream storing means for storing a plurality of bitstream data obtained by encoding a picture on an object-by-object basis, respectively;
a data receiving means for receiving priority information on priorities respectively assigned to objects transmitted from said moving picture receiver;
a selecting means for selecting one bitstream storing means from among said plurality of bitstream storing means based on the priority information received by said data receiving means; and
a bitstream transmitting means for transmitting bitstream data stored in said selected bitstream storing means.

9. The moving picture transmitter according to claim 8 characterized in that said plurality of bitstream storing means store a plurality of bitstream data obtained by encoding a same object with different bit rates, respectively.

10. The moving picture transmitter according to claim 8 characterized in that each of said plurality of bitstream storing means adds overhead information to a head of a predetermined frame of bitstream data and stores the bitstream data therein.

11. The moving picture transmitter according to claim 8 characterized in that each of said plurality of bitstream storing means stores bitstream data into which intraframe-predictive-encoded frames are inserted at predetermined intervals, and said selecting means switches from a selected one of said plurality of bitstream storing means to another bitstream storing means at a timing at which said selected bitstream storing means outputs an intraframe-predictive-encoded frame.

12. The moving picture transmitter according to claim 11 characterized in that each of said plurality of bitstream storing means produces position information on positions of the intraframe-predictive-encoded frames inserted into the bitstream data stored therein in advance.

13. The moving picture transmitter according to claim 8 characterized in that each of said plurality of bitstream storing means stores bitstream data to which predetermined overhead information is added, and when a same bitstream storing means has been continuously selected by said selecting means, said bitstream transmitting means removes the overhead information from the bitstream data being output from said selected bitstream storing means and transmits the bitstream data from which the overhead information has been removed.
